(19) United States
(12) Patent Application Publication
(10) Pub. No.: US 2026/0175124 A1
(43) Pub. Date: Jun. 25, 2026

(54) GAME INFORMATION DISPLAY METHOD AND APPARATUS, AND ELECTRONIC DEVICE

(71) Applicant: NETEASE (HANGZHOU) NETWORK CO., LTD., Hangzhou, Zhejiang (CN)

(72) Inventors: Ziyan ZHONG, Hangzhou, Zhejiang (CN); Li HANG, Hangzhou, Zhejiang (CN)

(73) Assignee: NETEASE (HANGZHOU) NETWORK CO., LTD., Hangzhou, Zhejiang (CN)

(21) Appl. No.: 19/128,734

(22) PCT Filed: Mar. 31, 2023
(86) PCT No.: PCT/CN2023/085461

§ 371 Date: May 9, 2025

(30) Foreign Application Priority Data
Nov. 11, 2022 (CN) 202211413514.0

(51) Int. Cl. A63F 13/525

(52) U.S. Cl. CPC A63F 13/525

(57) ABSTRACT

A game information display method includes: in response to a start command for a game session, controlling a controlled virtual character to enter a scene of the game session, and displaying a game session screen through a graphical user interface; in response to a first target game event for the controlled virtual character, controlling the controlled virtual character to leave the scene of the game session; and obtaining game data of teammate virtual characters, and changing the game session screen to a first game observation screen, which contains screens generated by virtual cameras collecting the scene of the game session and game result pictures.

### CROSS REFERENCE TO RELATED APPLICATIONS

The present disclosure is a U.S. national phase application of International Application No. PCT/CN 2023/085461, filed on Mar. 31, 2023, which is based upon and claims priority to Chinese Patent Application No. 202211413514.0, filed on Nov. 11, 2022 and entitled “GAME INFORMATION DISPLAY METHOD AND APPARATUS, AND ELECTRONIC DEVICE”, the entire contents of which are incorporated herein by reference.

### TECHNICAL FIELD

The present disclosure relates to the field of game technology, in particular to a game information display method, a game information display apparatus, and an electronic device.

### BACKGROUND

In some asymmetrical battle arena games, the player being chased may experience an evacuation phase in the game. During the evacuation phase, the player being chased is eliminated earlier or successfully evacuates, and needs to wait for other teammates to finish the game. Only when more than or equal to half of the teammates successfully evacuate, will they win the game.

### SUMMARY

In a first aspect, the present disclosure provide a game information display method, which provides a graphical user interface through a terminal device. The method includes: in response to a start command for a game session, controlling a controlled virtual character to enter a scene of the game session, and displaying a game session screen corresponding thereto through the graphical user interface, wherein the game session screen includes a screen formed by capturing the scene of the game session through a virtual camera corresponding to the controlled virtual character, and the scene of the game session includes at least two teammate virtual characters in the same camp as the controlled virtual character; in response to a first target game event for the controlled virtual character in the scene of the game session, controlling the controlled virtual character to leave the scene of the game session as a first identity; obtaining game data of the at least two teammate virtual characters, wherein the game data includes at least one of: result game data when leaving the scene of the game session and dynamic game data when in the scene of the game session; and controlling the game session screen currently displayed in the graphical user interface to change to a first game observation screen, wherein the first game observation screen includes at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto includes a screen formed by capturing the scene of the game session through a virtual camera corresponding to the teammate virtual character, and the game screen generated based on the result game data of the teammate virtual character corresponding thereto includes a game result picture corresponding to the result game data.

In a second aspect, the present disclosure provide a game information display apparatus, which provides a graphical user interface through a terminal device. The apparatus includes: a game session display module configured to in response to a start command for a game session, control a controlled virtual character to enter a scene of the game session, and display a game session screen corresponding thereto through the graphical user interface, wherein the game session screen includes a screen formed by capturing the scene of the game session through a virtual camera corresponding to the controlled virtual character, and the scene of the game session includes at least two teammate virtual characters in the same camp as the controlled virtual character; a first control module configured to in response to a first target game event for the controlled virtual character in the scene of the game session, control the controlled virtual character to leave the scene of the game session as a first identity; a game data obtaining module configured to obtain game data of the at least two teammate virtual characters, wherein the game data includes at least one of: result game data when leaving the scene of the game session and dynamic game data when in the scene of the game session; and a first game observation screen display module configured to control the game session screen currently displayed in the graphical user interface to change to a first game observation screen, wherein the first game observation screen includes at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto includes a screen formed by capturing the scene of the game session through a virtual camera corresponding to the teammate virtual character, and the game screen generated based on the result game data of the teammate virtual character corresponding thereto includes a game result picture corresponding to the result game data.

In a third aspect, the present disclosure provide an electronic device including a processor and a memory, wherein the memory is configured to store computer executable instructions that can be executed by the processor, and the processor is configured to execute the computer executable instructions to implement the game information display method described in any of the first aspect.

In a fourth aspect, the present disclosure provide a computer-readable storage medium having computer executable instructions stored thereon. When the computer executable instructions are called and executed by a processor, the computer executable instructions cause the processor to implement the game information display method described in any of the first aspect.

In order to make the above objectives, features, and advantages of the present disclosure more obvious and understandable, preferred embodiments and detailed explanations will be provided in the following in conjunction with the drawings.

### BRIEF DESCRIPTION OF THE DRAWINGS

In order to more clearly describe specific embodiments of the present disclosure or technical solutions in the prior art, drawings required in specific embodiments or in the prior art will be introduced briefly in the following. It is apparent that the drawings in the following are some embodiments of the present disclosure. For those of ordinary skill in the art, other related drawings can also be obtained according to these drawings without any creative efforts.

FIG. 1 is a schematic diagram of an information display method according to one or more embodiments of the present disclosure;

FIG. 2 is a schematic diagram of an information display method according to one or more embodiments of the present disclosure;

FIG. 3 is a flowchart of a game information display method according to one or more embodiments of the present disclosure;

FIG. 4 is a schematic diagram of a graphical user interface according to one or more embodiments of the present disclosure;

FIG. 5 is a schematic diagram of a graphical user interface according to one or more embodiments of the present disclosure;

FIG. 6 is a schematic diagram of a graphical user interface according to one or more embodiments of the present disclosure;

FIG. 7 is a schematic diagram of a structure of a game information display apparatus according to one or more embodiments of the present disclosure; and

FIG. 8 is a schematic diagram of a structure of an electronic device according to one or more embodiments of the present disclosure.

### DETAILED DESCRIPTION

In order to make purposes, technical solutions and advantages of embodiments of the present disclosure clearer, technical solutions according to embodiments of the present disclosure will be described clearly and completely below with reference to the drawings according to embodiments of the present disclosure. Obviously, embodiments described are some, but not all, embodiments of the present disclosure. All other embodiments obtained based on embodiments in the present disclosure, by those of ordinary skill in the art without any creative efforts, fall in the scope of the present disclosure.

In some asymmetrical battle arena games, the player being chased may experience an evacuation phase in the game. During the evacuation phase, the player being chased is eliminated earlier or successfully evacuates, and needs to wait for other teammates to finish the game. Only when more than or equal to half of the teammates successfully evacuate, will they win the game.

In the related art, during the evacuation phase, if the player being chased is eliminated earlier or successfully evacuates, game states of other teammates of the player are usually displayed in a graphical user interface, for example, displayed through icons or text, to represent the game states of other teammates. The display mechanism is triggered by data such as elimination and evacuation results, which are refreshed and synchronized to the player's front-end to update the display states of the icons or texts corresponding to the game results of other teammates.

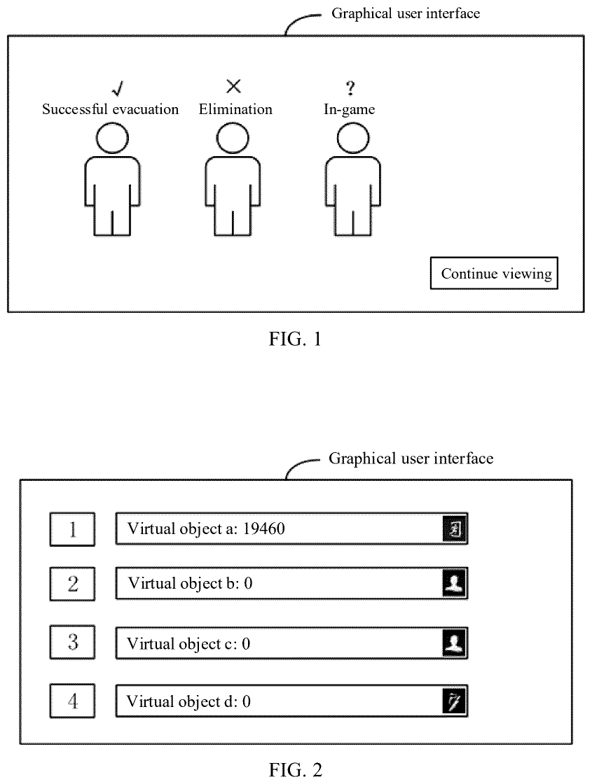

In some embodiments, as shown in FIG. 1, a schematic diagram of a user interface when a player enters a phase during which the player is waiting for other teammates to evacuate after a successful or failed evacuation is provided, where the user interface displays virtual characters controlled by each teammate, and icons and/or texts displayed above the virtual characters to indicate the teammates' game states, and the game states are, for example, in-game, successful evacuation, and elimination. If the player wants to view the game screens of her/his teammates in the game, she/he can click the ‘Continue Viewing’ button to enter the first person perspective of any player in the game for viewing. The user interface in this way displays texts and small icons when the player waits for other teammates to evacuate, which provides weak feedback on the teammates' game states, making it difficult for the player to learn the teammates' game states after their game states change. As a result, the player cannot quickly distinguish the game states of each teammate. In an observation interface, the player can only view the real-time game screen of one teammate at the same time, and may miss the game state changes of other players when the game ends.

In addition, as shown in FIG. 2, a schematic diagram of a user interface when a player enters a phase during which the player is waiting for other teammates to evacuate after a successful or failed evacuation is provided, where the icon on the right side of the user bar displays the user's game state (including in-game, successful evacuation, and elimination). In this display mode, if the player successfully or unsuccessfully evacuates in advance, she/he will be not able to see the specific behaviors of her/his teammates in the game, which results in a boring waiting process and a weak emotional connection with the teammates. In the display mode using icons, it is difficult for the player to learn the game state changes when the game ends due to the weak feedback.

The above display mode has weak feedback on the game states and does not have strong visual differentiation design, and the player cannot directly view actual game screens of teammates, which is not conducive to the player's quickly understanding the game state of each teammate. In addition, if the player being chased wants to view the game screens of her/his teammates, she/he can click a view button to display the game screen from the first person perspective of a designated or random teammate in the game. This will also result in a poor gaming experience of the player, for the player may miss the changes in the game states of other teammates.

Based on this, embodiments of the present disclosure provide a game information display method, a game information display apparatus, and an electronic device, which can be applied to terminal devices such as mobile phones, computers, tablets, and laptops, especially to devices on which the asymmetrical battle arena games are provided.

The game information display method provided in embodiments of the present disclosure can run on a local terminal device or a server. When the game information display method runs on a server, the method can be implemented and performed based on a cloud interaction system, which includes a server and a client device.

In some embodiments, various cloud applications, such as cloud games, can run in the cloud interaction system. The cloud game is taken as an example. The cloud game refers to a game style based on cloud computing. In the running mode of cloud games, the main body of the game program running and the main body of the game screen rendering are separated. The storage and running of information display methods in the game are completed on the cloud game server. The client device is used to receive and send data, as well as rendering the game screen. For example, the client device can be a display device with data transmission function close to the user's side, such as mobile terminals, televisions, computers, tablets, etc., but the information processing is carried out by the cloud game server in the cloud. When playing a game, the player operates the client device to send operation instructions to the cloud game server. The cloud game server runs the game according to the operation instructions, encodes and compresses the game screens and other data, which are then returned to the client device through the network. The game screens are finally decoded and output through the client device.

In some embodiments, taking the game as an example, the local terminal device is used to store the game program and render the game screens. The local terminal device can be used to interact with other players through the graphical user interface. That is, the player usually uses the electronic device to download and install the game program and runs the game program. The local terminal device can provide a graphical user interface to players in various ways, for example, rendering and displaying it on the terminal's display screen, or providing it to the player through holographic projection. In some embodiments, a local terminal device can include a display screen and a processor. The display screen is used to render the graphical user interface, which includes game screens. The processor is used to run the game, generate the graphical user interface, and control the display of the graphical user interface on the display screen.

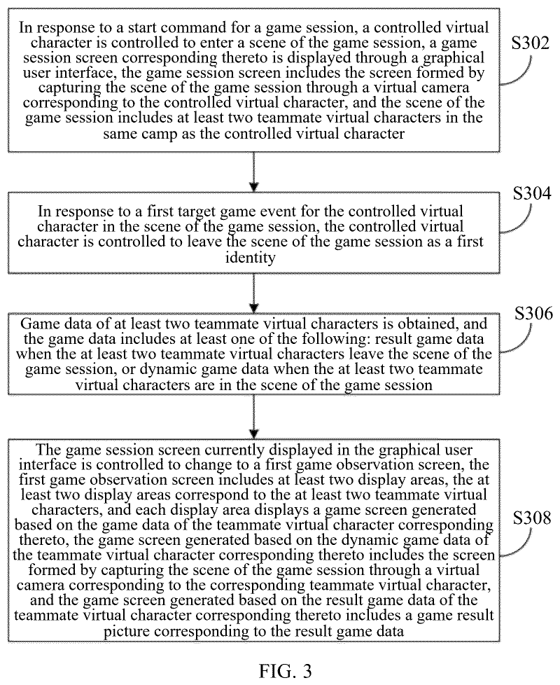

Embodiments of the present disclosure provide a game information display method. The method provides a graphical user interface through a terminal device. The terminal device can be the local terminal device mentioned above or the client device in the cloud interaction system mentioned above. As shown in FIG. 3, the method includes the following steps.

In step 302, in response to a start command for a game session, a controlled virtual character is controlled to enter a scene of the game session, and a game session screen corresponding thereto is displayed through a graphical user interface. The game session screen includes the screen formed by capturing the scene of the game session through a virtual camera corresponding to the controlled virtual character, and the scene of the game session includes at least two teammate virtual characters in the same camp as the controlled virtual character.

The controlled virtual character mentioned above is a party who flees or who is chased in the game session to avoid being caught. Multiple teammate virtual characters, such as two or three teammate virtual characters, of the controlled virtual character are usually included in the actual game session. The player can click on a game start control in a game start interface to control the controlled virtual character to enter the scene of the game session. At the same time, the game session screen for the scene of the game session will be displayed in the graphical user interface, and the game session screen can be a first person perspective of the controlled virtual character or a third person perspective of the controlled virtual character. Usually, a virtual character of at least one player, who belongs to a camp different from the controlled virtual character, is also included in the game session. The controlled virtual character is controlled through the terminal device.

In step S304, in response to a first target game event for the controlled virtual character in the scene of the game session, the controlled virtual character is controlled to leave the scene of the game session as a first identity.

The first target game event mentioned above usually refers to a game behavior of the controlled virtual character in the scene of the game session who completes the evacuation, which can be called successful evacuation. The successful evacuation usually means that the player controls the controlled virtual character to reach an evacuation location and leaves the scene of the game session from the evacuation location. There may also be instances of failed evacuation in the game session. The failed evacuation usually means that the controlled virtual character controlled by the player is eliminated (such as being defeated by the virtual character from the opposite party) on the way to the evacuation location, or the controlled virtual character does not reach the evacuation location and does not leave from the evacuation location before the countdown ends. The above leaving the scene of the game session as the first identity can be understood as the controlled virtual character leaving the scene of the game session as an identity of who successfully evacuates from the scene of the game session. That is, the above controlling the controlled virtual character to leave the scene of the game session means that the controlled virtual character ends its game in the game session.

In step S306, game data of at least two teammate virtual characters is obtained, and the game data includes at least one of the following: result game data when the at least two teammate virtual characters leave the scene of the game session, or dynamic game data when the at least two teammate virtual characters are in the scene of the game session.

The game data of the teammate virtual characters mentioned above is usually determined based on the game states of the teammate virtual characters. If the teammate virtual character successfully evacuates or fails to evacuate, that is, the teammate virtual character has left the scene of the game session, the game data of the teammate virtual character is the result game data of the teammate virtual character who has left the scene of the game session. The result game data at least includes game state information, a character number, a character pattern, etc. of the teammate virtual character. The game state information includes successful evacuation or failed evacuation (also known as elimination). If the teammate virtual character is in-game, that is, the teammate virtual character is in the scene of the game session, the game data of the teammate virtual character is dynamic game data of the teammate virtual character who is in the scene of the game session. The dynamic game data at least includes game state information, real-time game screen data, a character number, etc. of the teammate virtual character in the scene of the game session. The game state information includes in-evacuation or in-game. The real-time game screen data refers to the video frame data of the real-time game screen from the first person perspective of the teammate virtual character.

It should be noted that before the step of obtaining the game data of the at least two teammate virtual characters, the above method further includes: in response to a target event being triggered, obtaining the game data of the at least two teammate virtual characters. The target event is that the controlled virtual character is not the last one to leave the scene of the game session, and a number of virtual characters who have left the scene of the game session as the first identity (which can also be understood as successful evacuation) meets a relationship with a first preset threshold. The first preset threshold mentioned above is usually determined based on the number of the teammate virtual characters in the same camp as the controlled virtual character. In some embodiments, the first preset threshold is half of the total number of virtual characters in the same camp as the controlled virtual character. For example, if the number of all virtual characters in the same camp as the controlled virtual character is 4, then the first preset threshold mentioned above is 2. The number of virtual characters who have left the scene of the game session as the first identity meeting a relationship with the first preset threshold can be that the number of virtual characters who have left the scene of the game session as the first identity is less than the first preset threshold, or that the number of virtual characters who have left the scene of the game session as the first identity is less than or equal to the first preset threshold. According to the game rules, if the number of virtual characters who have left the scene of the game session as the first identity meets the relationship with the first preset threshold, the current game needs to be continued. In other words, after the controlled virtual character leaves the scene of the game session as the first identity, it is usually necessary to determine whether the team to which the controlled virtual character belongs wins the game and whether it loses the game. If the team does not win or lose the game, the game data of the teammate virtual characters of the player will be obtained.

In step S308, the game session screen currently displayed in the graphical user interface is controlled to change to a first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through a virtual camera corresponding to the corresponding teammate virtual character. The game screen generated based on the result game data of the teammate virtual character corresponding thereto includes a game result picture corresponding to the result game data.

The size and shape of the above display area can be pre-set according to the number of teammate virtual characters and the size of the graphical user interface. The size and shape of each display area can be the same or different. In some embodiments, a corresponding number of display areas are generated based on the number of teammate virtual characters, then the game screen of each teammate virtual character is generated based on the game data of that teammate virtual character, and the game screen of that teammate virtual character is displayed in the corresponding display area. The game screen includes the dynamic real-time game screen and the static image.

In some embodiments, the game session screen currently displayed in the graphical user interface is first controlled and changed to the first game observation screen, and then at least two display areas are generated on the first game observation screen. If the above game data is the dynamic game data of the teammate virtual character in the scene of the game session, then the real-time game screen is generated based on the dynamic game data. In some embodiments, virtual cameras corresponding to the teammate virtual characters are created in the scene of the game session, for the teammate virtual characters in the scene of the game session, and the first capture parameters are configured for the virtual cameras. The screens are formed by capturing the scene of the game session through the virtual cameras based on the first capture parameters, for example, the screens are obtained by capturing the scene of the game session through the virtual cameras corresponding to the teammate virtual characters in the scene of the game session. If there are multiple teammate virtual characters in the scene of the game session, the game session screen will be captured simultaneously through multiple virtual cameras corresponding to the teammate virtual characters in the scene of the game session.

If the above game data is the result game data of the teammate virtual character who has left the scene of the game session, then the game result picture is generated based on the result game data. The real-time game screen is displayed in the corresponding display area, and the game result picture is displayed in the corresponding display area. In this way, the game states of each teammate virtual character can be simultaneously displayed on the first game observation screen.

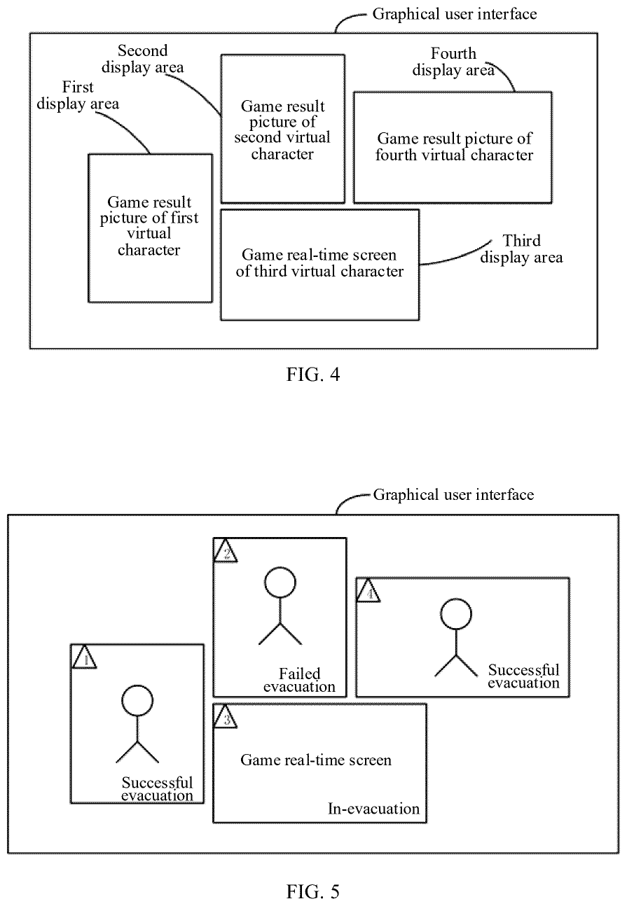

In some embodiments, the first game observation screen also includes a display area corresponding to the controlled virtual character, and the display area corresponding to the controlled virtual character displays the game screen generated based on the result game data of the controlled virtual character. In some embodiments, there are total 4 virtual characters including the teammate virtual characters and the controlled virtual characters mentioned above, and then four display areas are generated in the graphical user interface, as shown in FIG. 4, which includes four rectangular display areas. Among the 4 virtual characters, the first virtual character (also the controlled virtual character) and the fourth virtual character (teammate virtual character) are virtual characters who has left the scene of the game session as the first identity. The second virtual character (teammate virtual character) fails to evacuate, and the third virtual character (teammate virtual character) is in-game. Therefore, the game result pictures corresponding to the first virtual character, the second virtual character, and the fourth virtual character will be displayed in the first display area, the second display area, and the fourth display area, respectively, and at the same time, the real-time game screen corresponding to the third virtual character will be displayed in the third display area.

According to embodiments of the present disclosure, the game information display method is provided. In response to the start command for the game session, the controlled virtual character is controlled to enter the scene of the game session, and the game session screen is displayed through the graphical user interface. The game session screen includes the screen formed by capturing the scene of the game session through the virtual camera corresponding to the controlled virtual character, and the scene of the game session includes at least two teammate virtual characters in the same camp as the controlled virtual character. In response to the first target game event for the controlled virtual character in the scene of the game session, the controlled virtual character is controlled to leave the scene of the game session as the first identity. The game data of at least two teammate virtual characters is obtained, and the game data includes at least one of the following: result game data when the at least two teammate virtual characters leave the scene of the game session, or dynamic game data when the at least two teammate virtual characters are in the scene of the game session. The game session screen currently displayed in the graphical user interface is controlled to change to the first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data. In this way, real-time game screens and the game result pictures of each teammate virtual character can be respectively displayed by using at least two display areas, allowing players to quickly and simultaneously understand the game state of each teammate, which avoids the changes in the game states of other teammates being missed by the player, enriches players' information acquisition during the waiting process, enhances the emotional connection between players and teammates, and improves the players' gaming experiences.

After controlling and changing the game session screen currently displayed in the graphical user interface to the first game observation screen, the above method further includes following steps.

In response to the teammate virtual character being in the scene of the game session, the display area corresponding to the teammate virtual character is controlled to display a dynamic game screen generated based on the dynamic game data of the teammate virtual character. In response to the teammate virtual character leaving the scene of the game session, the dynamic game screen currently displayed in the display area is controlled to change to a game result picture generated based on the result game data of the teammate virtual character.

That is, the display area corresponding to the teammate virtual character in the scene of the game session will display the real-time game screen of the teammate virtual character in real time. As long as the teammate virtual character has not left the scene of the game session, the corresponding display area will always display the real-time game screen of the teammate virtual character. However, when the teammate virtual character in the scene of the game session leaves the scene of the game session, for example, when the teammate virtual character is eliminated or successfully evacuates, the corresponding display area will be controlled to change from the real-time game screen of the teammate virtual character to the game result picture. The game result picture is generated based on the result game data of the teammate virtual character.

The above steps have a prerequisite, that is, when the player is waiting for her/his teammates to evacuate, the number of the teammate virtual characters in the evacuation process needs to be greater than or equal to two. If the evacuation is successful or fails, the changes in the game states of the teammate virtual characters will be displayed in the display area of the player's graphical user interface. In some embodiments, if the teammate virtual character in the game successfully evacuates, the display area is controlled to change from the real-time game screen to the first game result picture of the teammate virtual character. If the teammate virtual character in the game fails to evacuate, the display area is controlled to change from the real-time game screen to the second game result picture of the teammate virtual character. In this way, when a teammate virtual character leaves the scene of the game session, the display area corresponding to the teammate virtual character is triggered to change the game state, and the corresponding game result picture is displayed through visual effects, which meets the player's demand for real-time acquisition of game states and further improves the player's gaming experience.

The above method further includes: in response to an attribute value of the controlled virtual character meeting a first preset condition, the controlled virtual character is controlled to leave the scene of the game session as a second identity, and the game session screen currently displayed in the graphical user interface is controlled to change to a second game observation screen. The second game observation screen displays a game screen of a teammate virtual character in the scene of the game session.

The attribute value of the controlled virtual character mentioned above usually refers to a health point of the controlled virtual character. When the health point of the controlled virtual character is zero, the controlled virtual character is controlled to leave the scene of the game session as the second identity. In other words, if the attribute value of the controlled virtual character meets the first preset condition, it means that the controlled virtual character is defeated and knocked down by other virtual characters in the scene of the game session. The controlled virtual character leaving the scene of the game session as the second identity mentioned above means that the controlled virtual character is eliminated. At this time, other virtual characters in the scene of the game session are not affected and will continue the game session.

In some embodiments, if the controlled virtual character is defeated, the graphical user interface is switched automatically from the game session screen to the real-time game screen of a designated virtual character (i.e. the second game observation screen mentioned above), and thus entering a regular observation mode. The designated virtual character usually refers to any one of all teammate virtual characters. When viewing the game, the player can click on an end control displayed in the graphical user interface to control the graphical user interface to cancel the display of the real-time game screen of the specified virtual character and to switch to the main interface of the game.

It should be noted that displaying the real-time game screen of each teammate virtual character in multiple display areas in the graphical user interface is different from displaying the real-time game screen of teammate virtual character on the second game observation screen after the controlled virtual character is eliminated in the above step.

First, the ways of controlling the virtual cameras are different. In the second game observation screen, only one teammate virtual character's real-time game screen can be displayed, and there is only one display window (i.e. only one virtual camera viewport). The player can switch and observe real-time game screens of different teammate virtual characters through switching operations. At this time, a new virtual camera needs to be generated to capture the switched teammate virtual character in the scene of the game session. Alternatively, similar to the technique of displaying the first observation screen, a virtual camera can be generated for each teammate virtual character who has not left the scene of the game session. When the player switches to the target teammate virtual character and wants to view the real-time game screen of the target teammate virtual character, the pre-generated virtual camera corresponding to the target teammate virtual character will be activated to obtain the real-time game screen of the target teammate virtual character, which will be displayed in the display area of the second game observation screen. For the first game observation screen, a corresponding number of display areas are generated according to the number of teammate virtual characters, and the screens captured by the virtual cameras corresponding to the teammate virtual characters in the scene of the game session are displayed simultaneously through each display area.

Second, the camera parameters of the virtual cameras are different. The real-time game screen on the second game observation screen is obtained by capturing the back or the back of the head of the teammate virtual character through the virtual camera corresponding to the teammate virtual character, which is from conventional first game perspective or third game perspective. On the first game observation screen, the real-time game screen of the teammate virtual character in the scene of the game session displayed in the display area is captured by the virtual camera corresponding to the teammate virtual character. The captured image can be the side face of the teammate virtual character, the top of the head of the teammate virtual character, or any angle of the teammate virtual character. In this way, the real-time game screen displayed on the first game observation screen can be more interesting.

Before the step of controlling, in response to the first target game event for the controlled virtual character in the scene of the game session, the controlled virtual character to leave the scene of the game session as the first identity, the method further includes following steps.

In response to a game task of the game session meeting a second preset condition, a target virtual object is provided in the scene of the game session, and a triggering event for the target virtual object is configured for a target game behavior being to perform by the virtual character in the scene of the game session.

The above game task is usually a task pre-set by the game or the player, and the controlled virtual character is a party who flees or who is chased in the game. In the game, the controlled virtual character usually has multiple teammates, and the player needs to control the controlled virtual character to complete the game task(s) in the scene of the game session. At the same time, the teammate players may also need to control their teammate virtual characters to complete the above game task(s) in the scene of the game session. The game task(s) can include finding target items, defeating target characters, or reaching target locations, etc. When both the controlled virtual character and the teammate virtual characters have completed the above game task(s), the game can be controlled to enter the evacuation phase.

During the evacuation phase of the game, the target virtual object will be provided in the scene of the game session, which can be a virtual plane, a target exit, a target gate, etc. Providing the target virtual object in the scene of the game session can be summoning the virtual airplane in the scene of the game session, generating an exit in the scene of the game session, activating the target exit in the scene of the game session, or temporarily opening the target gate in the scene of the game session.

The configuration of the triggering event for the target virtual object mentioned above is that a target game behavior is performed by the virtual character in the scene of the game session, where the target game behavior can be the virtual character moving to the target virtual object, or the virtual character being located at the designated position of the target virtual object, etc. For example, when the virtual character in the game session moves to the target gate, the virtual character will leave the scene of the game session as the first identity, or when the virtual character in the scene of the game session rides on the virtual plane, the virtual plane will start and take the virtual character away from the scene of the game session as the first identity.

In some embodiments, during the process of controlling the controlled virtual character to reach the target virtual object, the player may need to engage in battles with the encountered target character, and only proceed after defeating the target character.

In some embodiments, if the game task in the game session meets the second preset condition, the evacuation countdown will also be initiated. The evacuation countdown usually takes a specified time, such as 5 or 10 minutes. In other words, after the game session enters the evacuation phase, the virtual characters in the scene of the game session need to complete the evacuation actions within the specified time, otherwise, it will be considered that the virtual character's evacuation has failed, and the game session will also end.

The above method further includes: in response to the attribute value of the controlled virtual character meeting the first preset condition, the controlled virtual character is controlled to leave the scene of the game session as the second identity. The game data of at least two teammate virtual characters is obtained, and the game data includes at least one of the following: result game data when the at least two teammate virtual characters leave the scene of the game session, or dynamic game data when the at least two teammate virtual characters are in the scene of the game session. The game session screen currently displayed in the graphical user interface is controlled to change to the first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data.

In some embodiments, if the controlled virtual character is eliminated during the evacuation phase of the game session, the controlled virtual character leaves the scene of the game session as the second identity. The subsequent steps are the same as steps S306 and S308 mentioned above, and will not be repeated here.

The game result picture corresponding to the result game data of the teammate virtual character mentioned above includes at least one of the following: the teammate virtual character, a character number of the teammate virtual character, and a game result identifier of the teammate virtual character. The game result identifier is used to indicate that the first target game event related to the teammate virtual character or the attribute value of the teammate virtual character meets the first preset condition.

The above game result identifier can be a pattern identifier or a text identifier. In some embodiments, what the above game result identifier is used to indicate that the first target game event related to the teammate virtual character or the attribute value of the teammate virtual character meets the first preset condition, means that the game result identifier can be used to indicate that the teammate virtual character has successfully evacuated or has been eliminated (failed to evacuate). For example, there are four teammate virtual characters and the controlled virtual character in total. The first virtual character (also the controlled virtual character, with the character number “1”) and the fourth teammate virtual character (character number “4”) successfully evacuate, the second teammate virtual character (character number “2”) is eliminated (or fails to evacuate), and the third teammate virtual character (character number “3”) is in the scene of the game session. At this time, the game result pictures of the first controlled virtual character, the second teammate virtual character, and the fourth teammate virtual character will be displayed in the corresponding first display area, second display area, and fourth display area, respectively. At the same time, the real-time game screen of the third teammate virtual character will be displayed in the corresponding third display area. For example, as shown in FIG. 5, the character numbers “1”, “2”, and “4” of the virtual characters are included at the upper left corner of the game result picture, the character patterns of the virtual characters are displayed in the middle, and the game result identifiers of the virtual characters are displayed at the lower right corner, including the texts “successful evacuation” and “failed evacuation”. The real-time game screen in FIG. 5 also includes the character number “3” of the target virtual character at the upper left corner, and the game result identifier “in-evacuation” of the target virtual character is displayed at the lower right corner.

In this way, the game states of teammates can be displayed simultaneously in the graphical user interface, and the specific behaviors of teammates in the game can be learned in real time, so as to meet the user's need of viewing all teammates' states simultaneously.

The result game data of the teammate virtual character mentioned above includes first result game data and second result game data. The display format of the teammate virtual character included in the first game result picture corresponding to the first result game data is the first display format. That the first game result picture includes the first game result identifier of the teammate virtual character is used to indicate the first target game event related to the teammate virtual character. The display format of the teammate virtual character included in the second game result picture corresponding to the second result game data is the second display format. That the second game result picture includes the second game result identifier of the teammate virtual character is used to indicate that the attribute value of the teammate virtual character meets the first preset condition.

The first display format mentioned above can be color highlight display, flashing display, etc. In addition, the background of the first game result picture can also be white or color. The second display format mentioned above can be gray display, and the background of the second game result picture can also be black or gray, etc. In some embodiments, the display format of the first game result identifier can also be the first display format, and the display format of the second game result identifier can also be the second display format. For example, the first game result identifier mentioned above is used to indicate the first target game event related to the teammate virtual character, which can be used to indicate that the teammate virtual character has successfully evacuated. For example, the second game result identifier mentioned above is used to indicate that the attribute value of the teammate virtual character meets the first preset condition, which can be that the teammate virtual character has been eliminated (or has not successfully evacuated).

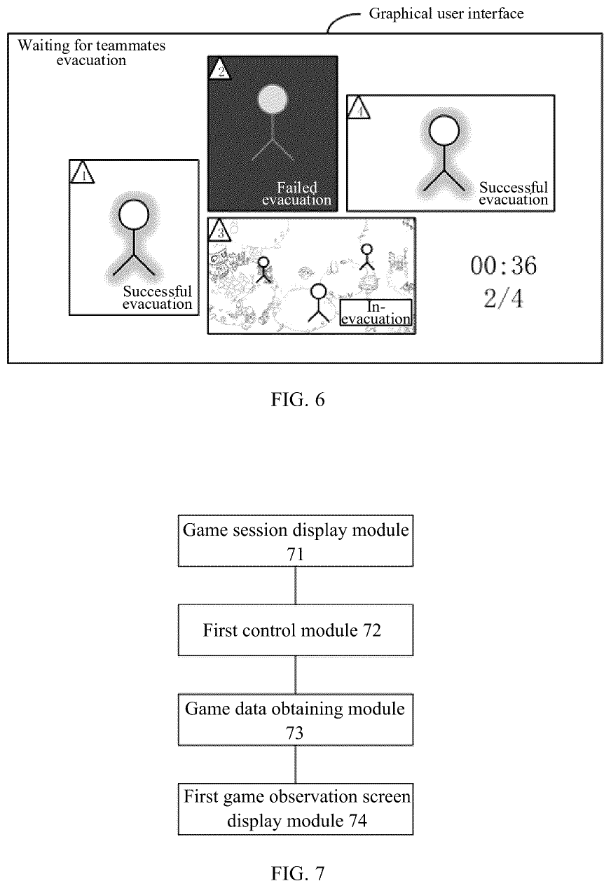

For example, as shown in FIG. 6, the background of the first game result pictures of virtual characters with character numbers “1” and “4” are white, and the virtual characters therein are highlighted in gray (usually highlighted in color in actual games). In addition, in actual games, “successful evacuation” is usually highlighted in color. The background of the second game result picture of the virtual character with character number “2” is black, and the virtual character therein is displayed in gray.

The first display format mentioned above is used to enhance the visual display effect applied to the first game result picture, and the second display format is used to weaken the visual display effect applied to the second game result picture. For the display area of the virtual character whose game state is successful evacuation/failed evacuation, the character image corresponding to the player and larger artistic words of successful evacuation or failed evacuation are displayed. The character image corresponding to the player who has been eliminated are processed in black and white, which is visually differentiated from successfully evacuated players, so that the feedback on the individual game outcome can be enhanced.

The game screen generated based on the dynamic game data of the teammate virtual character corresponding thereto also includes the game result identifier of the teammate virtual character. The game result identifier is used to indicate that the teammate virtual character is in the scene of the game session.

In some embodiments, a virtual camera is created to follow the teammate virtual character in the scene of the game session, so as to capture and obtain the real-time game screen of the teammate virtual character from the first person perspective. The real-time game screen is then rendered to the display area of the interface where the user is waiting to evacuate. For example, the above game result identifier is used to indicate that the teammate virtual character is in the scene of the game session, and can be used to indicate that the teammate virtual character is in evacuation. As shown in FIG. 6, the display area corresponding to the teammate virtual character with character number “3” displays the real-time game screen of the teammate virtual character, as well as displaying the game result identifier “in-evacuation” at the same time.

In addition, the real-time game screen mentioned above are captured by the virtual camera, so the information about the controls in the graphical user interface of the teammate player will not be displayed in the screen, reducing the performance consumption of the terminal device and minimizing the interference of invalid controls on the teammate's game screen that the player is more concerned about at this time.

The above method further includes: a resolution and/or a video frame rate of the game screen generated based on the dynamic game data of the corresponding teammate virtual character is increased or decreased according to the device performance of the terminal device, and a processed game screen is controlled to be displayed in the display area.

Due to the different models of terminal devices used by players, and due to the poor performance of low-end terminal device, if the real-time game screen is displayed with good image quality and resolution, it may cause lag or even device crashes. Based on this, in embodiments of the present disclosure, when the real-time game screen is displayed in the display area, the device model and the performance parameter of the terminal device will be obtained. If the device is a high-end model with high performance parameters, the resolution and the video frame rate of the real-time game screen of the teammate virtual character can be increased. If the device is a low-end model with low performance parameters, the resolution and the video frame rate of the real-time game screen of the teammate virtual character can be reduced, or the resolution or the video frame rate of the real-time game screen of the teammate virtual character can be reduced. In this way, the image quality and the video frame rate of the game screen can be actively reduced or increased, considering the performance consumption of the device, so as to reduce the performance consumption of the device and improve the stability of the game.

The first game observation screen also includes countdown to the game session, a first value, and a second value. The countdown to the game session is used to indicate the remaining game time for the teammate virtual character. The first value is used to indicate the number of virtual characters who leave the scene of the game session as the first identity, and the second value is used to indicate a sum of the number of the controlled virtual character and the teammate virtual characters.

As shown in FIG. 6, the countdown “00:36” to the game session (also known as the evacuation countdown) is displayed at the lower right corner of the graphical user interface, which indicates that the virtual character still has 36 seconds or 36 minutes left in the game. The first value “2” and the second value “4” are displayed below the countdown to the game session. The first value “2” indicates that two virtual characters have successfully evacuated, and the second value “4” indicates that there are a total of 4 virtual characters in the scene of the game session that need to complete evacuation tasks.

In this way, by displaying the remaining time for the game session, as well as the number of successfully evacuated virtual characters and the number of all virtual characters from the party needing to evacuate, the player can learn the current game progress more quickly.

The above method further includes: in response to a specified event being triggered, the game session is controlled to end, and the first game observation screen displayed in the graphical user interface is controlled to change to a game settlement screen. The specified event includes: the countdown to the game session ends or at least two teammate virtual characters leave the scene of the game session.

The meaning is that when the countdown to the game session ends or all teammate virtual characters successfully evacuate or fail to evacuate (are eliminated), the game is controlled to end and the display of the first game observation screen is cancelled, thereby displaying the game settlement screen or other screens.

An example implementation

In response to the number of virtual characters who have left the scene of the game session as the first identity meeting the preset threshold, the game session is controlled to win, and the first game observation screen displayed in the graphical user interface is controlled to change to the first game settlement screen. The first game settlement screen includes victory information about the game session. In response to the number of virtual characters who have left the scene of the game session as the first identity not meeting the preset threshold, the game session is controlled to fail, and the first game observation screen displayed in the graphical user interface is controlled to change to the second game settlement screen. The second game settlement screen includes failure information about the game session.

The above preset threshold can be determined based on the number of controlled virtual characters and the number of teammate virtual characters, for example, the preset threshold can be half of the number of controlled virtual characters and the number of teammate virtual characters. That the number of virtual characters who have successfully evacuated meets the relationship with the preset threshold, can be that the number of virtual characters who have successfully evacuated is greater than the second preset threshold, or that the number of virtual characters who have successfully evacuated is greater than or equal to the second preset threshold. That the number of virtual characters who have successfully evacuated does not meet the relationship with the second preset threshold, can be that the number of virtual characters who have successfully evacuated is less than the second preset threshold, or that the number of virtual characters who have successfully evacuated is less than or equal to the second preset threshold.

In some embodiments, when all teammate virtual characters have successfully evacuated or failed to evacuate, it is necessary to determine the number of virtual characters who have successfully evacuated. If the number of all virtual characters from the party needing to evacuate is 4, the preset threshold can be 2. If the number of virtual characters who have successfully evacuated is 3, which is greater than 2, the game session is controlled to win, and the graphical user interface is controlled to switch from the display area to the first game settlement screen, which includes victory feedback information on the game session.

In some embodiments, when all teammate virtual characters have successfully evacuated or failed to evacuate, it is necessary to determine the number of virtual characters who have successfully evacuated. If the number of virtual characters is 4, the preset threshold can be 2. If the number of virtual characters who have successfully evacuated is 1, which is less than 2, the game is controlled to fail, and the graphical user interface is controlled to switch from the display area to display the second game settlement screen, which includes failure feedback information on the game session.

An example implementation of the above steps of increasing or decreasing, according to the device performance of the terminal device, the resolution and/or the video frame rate of the game screen generated based on the dynamic game data of the corresponding teammate virtual character, is as follows.

If the device performance of the terminal device is lower than the preset performance, the game screen generated based on the dynamic game data of the corresponding teammate virtual character is controlled to be updated to the game result picture corresponding to the dynamic game data. The game result picture at least includes: the teammate virtual character, the character number of the teammate virtual character, and the game result identifier of the teammate virtual character, which are displayed in the third display format. The game result identifier is used to indicate that the teammate virtual character is in the scene of the game session.

Considering that directly displaying the real-time game screen may cause device lag and unstable running of the game, when the device performance of the terminal device is lower than the preset performance, the display of the real-time game screen of the target teammate virtual character in the game can be temporarily stopped, merely displaying the game result picture. The teammate virtual character in the picture is usually displayed in the first display format, but can also be displayed in other formats. The above game result identifier is marked as “in-evacuation”. In this way, it is displayed that the teammate virtual character is in the game by displaying pictures, further reducing the performance consumption of the device.

In addition, when all display areas in the graphical user interface show game result pictures, if the player wants to learn the specific game behaviors of the teammate virtual character in the game, the player can click on the corresponding game result picture to view the real-time game screen of the teammate virtual character in the game.

The above method further includes: in response to a triggering operation on the game screen generated based on the dynamic game data of the corresponding teammate virtual character, the graphical user interface is controlled to enlarge and display the game screen generated based on the dynamic game data of the corresponding teammate virtual character. In response to the triggering operation on the game screen generated based on the result game data of the corresponding teammate virtual character, the corresponding display area is controlled to switch and display game related data of the virtual character corresponding thereto. The game related data at least includes: the character level, the game time, and the game ranking of the corresponding teammate virtual character.

If the player wants to learn more detailed game information about virtual characters who have successfully evacuated or failed to evacuate, she/he can directly click on the game result picture to control the display area on the first game observation screen to switch and display the game related data of the teammate virtual character. In some embodiments, the game related data can be displayed in full screen or in the display area. If the player only cares about the teammate virtual characters in the game, she/he can click on the real-time game screen displayed in the display area to display the real-time game screen in full screen.

The above method includes: if the number of teammate virtual characters greater than or equal to a specified threshold, the first game observation screen includes a partial display area. In response to a sliding operation on the first game observation screen, the partial display area on the first game observation screen is controlled to move towards a sliding direction of the sliding operation, and a hidden display area on the first game observation screen is controlled to be displayed.

Considering that there are many virtual teammates, if too many display areas are generated on the first game observation screen, the display area will be relatively small. To avoid the display area shrinking, a suitable size of display area can be generated. If it is impossible to display all display areas on current first game observation screen, some of the display areas will be hidden. The player can display the hidden display areas by sliding the screen.

In the above embodiments, the user interface when the player is waiting for the evacuation phase is divided into four display areas, simulating the split screen, and displaying the states of the four players from the part who needs to evacuate in the session, respectively, so as to meet the user's need of viewing the states of all teammates simultaneously. In the display area corresponding to the player whose game state is successful evacuation/failed evacuation, the player's corresponding character image and larger artistic words of successful evacuation/failed evacuation are displayed. The character image corresponding to the player who has been eliminated are processed in black and white, which is visually differentiated from successfully evacuated players, so that the feedback on the individual game outcome can be enhanced. The player's split screen in the game calls the real-time game screen of the player, and thus the user can see the specific behaviors of their teammates in the game, enriching her/his information acquisition during the waiting process, and enhancing the emotional connection with the teammates.

In some embodiments, the user interface when the player is waiting in the evacuation phase of the teammates is divided based on the number of players on user's own side, simultaneously displaying the states of all teammates, which can meet the user's need of obtaining real-time battle information. Visual effects are used to switch screen information between game players who are in-game and game players who ends the game, enhancing feedback on key state changes in the game, and strengthening result feedback on users' waiting behaviors. The comparison and processing of character images between eliminated players and successfully evacuated players are used to visually differentiate and enhance the feedback of individual game results, while also enhancing the sense of achievement of successfully evacuated players. By using the technology of calling real-time game screens in the player's split screen in the game, the user can see the specific behaviors of her/his teammates in the game, and the emotional connection between the user and all teammates can be enhanced, in combination with the split screen technology.

Embodiments of the present disclosure provide a game information display apparatus corresponding to the above method embodiments. The game information display apparatus provides a graphical user interface through a terminal device, as shown in FIG. 7. The apparatus includes a game session display module 71, a first control module 72, a game data obtaining module 73, and a first game observation screen display module 74.

The game session display module 71 is configured to in response to a start command for a game session, control a controlled virtual character to enter a scene of the game session, and display a game session screen corresponding thereto through the graphical user interface, wherein the game session screen includes a screen formed by capturing the scene of the game session through a virtual camera corresponding to the controlled virtual character, and the scene of the game session includes at least two teammate virtual characters in the same camp as the controlled virtual character.

The first control module 72 is configured to in response to a first target game event for the controlled virtual character in the scene of the game session, control the controlled virtual character to leave the scene of the game session as a first identity.

The game data obtaining module 73 is configured to obtain game data of the at least two teammate virtual characters, wherein the game data includes at least one of: result game data when leaving the scene of the game session and dynamic game data when in the scene of the game session.

The first game observation screen display module 74 is configured to control the game session screen currently displayed in the graphical user interface to change to a first game observation screen, wherein the first game observation screen includes at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto includes a screen formed by capturing the scene of the game session through a virtual camera corresponding to the teammate virtual character, and the game screen generated based on the result game data of the teammate virtual character corresponding thereto includes a game result picture corresponding to the result game data.

According to embodiments of the present disclosure, the game information display apparatus is provided. In response to the start command for the game session, the controlled virtual character is controlled to enter the scene of the game session, and the game session screen is displayed through the graphical user interface. The game session screen includes the screen formed by capturing the scene of the game session through the virtual camera corresponding to the controlled virtual character, and the scene of the game session includes at least two teammate virtual characters in the same camp as the controlled virtual character. In response to the first target game event for the controlled virtual character in the scene of the game session, the controlled virtual character is controlled to leave the scene of the game session as the first identity. The game data of at least two teammate virtual characters is obtained, and the game data includes at least one of the following: result game data when the at least two teammate virtual characters leave the scene of the game session, or dynamic game data when the at least two teammate virtual characters are in the scene of the game session. The game session screen currently displayed in the graphical user interface is controlled to change to the first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data. In this way, real-time game screens and the game result pictures of each teammate virtual character can be respectively displayed by using at least two display areas, allowing players to quickly and simultaneously understand the game state of each teammate, which avoids the changes in the game states of other teammates being missed by the player, enriches players' information acquisition during the waiting process, enhances the emotional connection between players and teammates, and improves the players' gaming experiences.

The above apparatus further includes a second control module, which is configured to in response to the teammate virtual character being in the scene of the game session, control the display area corresponding to the teammate virtual character to display a dynamic game screen generated based on the dynamic game data of the teammate virtual character; and in response to the teammate virtual character leaving the scene of the game session, control the dynamic game screen currently displayed in the display area to change to a game result picture generated based on the result game data of the teammate virtual character.

The above apparatus further includes a third control module, which is configured to in response to an attribute value of the controlled virtual character meeting a first preset condition, control the controlled virtual character to leave the scene of the game session as a second identity, and control the game session screen currently displayed in the graphical user interface to change to a second game observation screen, wherein the second game observation screen displays a game screen of a teammate virtual character in the scene of the game session.

The above apparatus further includes a target virtual object providing module, which is configured to provide a target virtual object in the scene of the game session in response to a game task of the game session meeting a second preset condition. A triggering event for the target virtual object is configured for a target game behavior being to perform by the virtual character in the scene of the game session.

The above apparatus further includes a fourth control module, which is configured to in response to the attribute value of the controlled virtual character meeting the first preset condition, control the controlled virtual character to leave the scene of the game session as the second identity; obtain the game data of at least two teammate virtual characters, wherein the game data includes at least one of the following: result game data when the at least two teammate virtual characters leave the scene of the game session, or dynamic game data when the at least two teammate virtual characters are in the scene of the game session; and control the game session screen currently displayed in the graphical user interface to change to the first game observation screen, wherein the first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data.

The game result picture corresponding to the result game data of the teammate virtual character mentioned above includes at least one of the following: the teammate virtual character, a character number of the teammate virtual character, and a game result identifier of the teammate virtual character. The game result identifier is used to indicate that the first target game event related to the teammate virtual character or the attribute value of the teammate virtual character meets the first preset condition.

The result game data of the teammate virtual character mentioned above includes first result game data and second result game data. The display format of the teammate virtual character included in the first game result picture corresponding to the first result game data is the first display format. That the first game result picture includes the first game result identifier of the teammate virtual character is used to indicate the first target game event related to the teammate virtual character. The display format of the teammate virtual character included in the second game result picture corresponding to the second result game data is the second display format. That the second game result picture includes the second game result identifier of the teammate virtual character is used to indicate that the attribute value of the teammate virtual character meets the first preset condition.

The first display format mentioned above is used to enhance the visual display effect applied to the first game result picture, and the second display format is used to weaken the visual display effect applied to the second game result picture.

The game screen generated based on the dynamic game data of the teammate virtual character corresponding thereto also includes the game result identifier of the teammate virtual character. The game result identifier is used to indicate that the teammate virtual character is in the scene of the game session.

The first game observation screen mentioned above also includes a display area corresponding to the controlled virtual character, and the display area corresponding to the controlled virtual character displays the game screen generated based on the result game data of the controlled virtual character.

The above apparatus further includes a screen adjustment module, which is configured to increase or decrease a resolution and/or a video frame rate of the game screen generated based on the dynamic game data of the corresponding teammate virtual character according to the device performance of the terminal device.

The first game observation screen mentioned above also includes countdown to the game session. The countdown to the game session is used to indicate the remaining game time for the teammate virtual character.

The first game observation screen also includes a first value and a second value. The first value is used to indicate the number of virtual characters who leave the scene of the game session as the first identity, and the second value is used to indicate a sum of the number of the controlled virtual character and the teammate virtual characters.

The above apparatus further includes a fifth control module, which is configured to in response to a specified event being triggered, control the game session to end, and control the first game observation screen displayed in the graphical user interface to change to a game settlement screen. The specified event includes: the countdown to the game session ends or at least two teammate virtual characters leave the scene of the game session.

The fifth control module mentioned above is further configured to: in response to the number of virtual characters who have left the scene of the game session as the first identity meeting the preset threshold, control the game session to win, and control the first game observation screen displayed in the graphical user interface to change to the first game settlement screen, wherein the first game settlement screen includes victory information about the game session; and in response to the number of virtual characters who have left the scene of the game session as the first identity not meeting the preset threshold, control the game session to fail, and control the first game observation screen displayed in the graphical user interface to change to the second game settlement screen, wherein the second game settlement screen includes failure information about the game session.

The above screen adjustment module is further configured to: if the device performance of the terminal device is lower than the preset performance, control the game screen generated based on the dynamic game data of the corresponding teammate virtual character to be updated to the game result picture corresponding to the dynamic game data. The game result picture at least includes: the teammate virtual character, the character number of the teammate virtual character, and the game result identifier of the teammate virtual character, which are displayed in the third display format. The game result identifier is used to indicate that the teammate virtual character is in the scene of the game session.

The apparatus mentioned above also includes a sixth control module, which is configured to: in response to a triggering operation on the game screen generated based on the dynamic game data of the corresponding teammate virtual character, control the graphical user interface to enlarge and display the game screen generated based on the dynamic game data of the corresponding teammate virtual character, and in response to the triggering operation on the game screen generated based on the result game data of the corresponding teammate virtual character, control the corresponding display area to switch and display game related data of the virtual character corresponding thereto. The game related data at least includes: the character level, the game time, and the game ranking of the corresponding teammate virtual character.

The apparatus mentioned above also includes a seventh control module, which is configured to: if the number of teammate virtual characters greater than or equal to a specified threshold, the first game observation screen including a partial display area, in response to a sliding operation on the first game observation screen, control the partial display area on the first game observation screen to move towards a sliding direction of the sliding operation, and control a hidden display area on the first game observation screen to be displayed.

The game information display apparatus provided in embodiments of the present disclosure has the same technical features as the game information display method provided in the above embodiments, which can also solve the same technical problem and achieve the same technical effect.

Embodiments of the present disclosure also provide an electronic device including a processor and a memory. The memory stores computer executable instructions that can be executed by the processor. The processor executes the computer executable instructions to cause the above game information display method to be implemented. The electronic device can be a server or a terminal device.

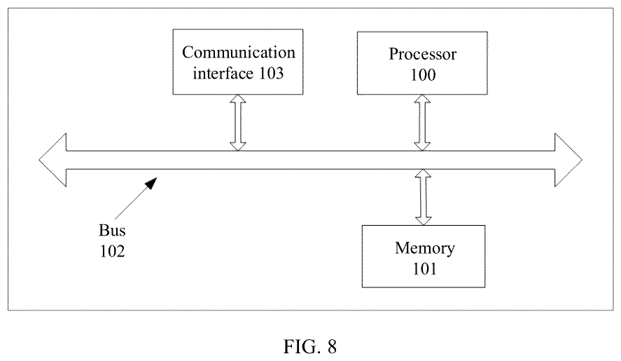

As shown in FIG. 8, the electronic device includes a processor 100 and a memory 101. The memory 101 stores machine executable instructions that can be executed by the processor 100. The processor 100 executes the computer executable instructions to cause the above game information display method to be implemented.

In some embodiments, the electronic device shown in FIG. 8 further includes a bus 102 and a communication interface 103, and the processor 100, the communication interface 103, and memory 101 are connected through the bus 102.

In some embodiments, the memory 101 may include the high-speed random access memory (RAM), as well as the non-volatile memory, such as at least one disk storage. The communication connection between the system network element and at least one other network element is realized through at least one communication interface 103 (which can be wired or wireless), where the Internet, the wide area network, the local wide area network, the metropolitan area network, etc., can be used. The bus 102 can be an ISA bus, a PCI bus, or an EISA bus, etc. The bus can be divided into the address bus, the data bus, the control bus, etc. For ease of representation, only one bidirectional arrow is used in FIG. 8, but it does not mean that there is only one bus or one type of bus.

The processor 100 may be an integrated circuit chip with signal processing capability. In the implementation process, each step of the above methods can be completed through the integrated logic circuit of the hardware or software instructions in the processor 100. The above processor 100 can be a general-purpose processor, including a central processing unit (CPU), a network processor (NP), etc. It can also be a digital signal processor (DSP for short), an application specific integrated circuit (ASIC), a field programmable gate array (FPGA), or other programmable logic devices, discrete gates or transistor logic devices, or discrete hardware components. The methods, steps, and logical diagrams disclosed in embodiments of the present disclosure can be implemented or executed. The general-purpose processor can be a microprocessor or any conventional processor. The steps of the methods disclosed in embodiments of the present disclosure can be directly embodied in the achievement by the hardware decoding processor or the combination of hardware and software modules in the decoding processor. Software modules can be located in mature storage media in in the RAM, flash memory, read-only memory, programmable read-only memory or electrically erasable programmable memory. The storage medium is located in the memory 101, and the processor 100 reads the information in the memory 101 and completes the steps of the game information display method described in the aforementioned embodiments in combination with its hardware. The method includes following steps.

In response to the start command for the game session, the controlled virtual character is controlled to enter the scene of the game session, and the game session screen is displayed through the graphical user interface. The game session screen includes the screen formed by capturing the scene of the game session through the virtual camera corresponding to the controlled virtual character, and the scene of the game session includes at least two teammate virtual characters in the same camp as the controlled virtual character. In response to the first target game event for the controlled virtual character in the scene of the game session, the controlled virtual character is controlled to leave the scene of the game session as the first identity. The game data of at least two teammate virtual characters is obtained, and the game data includes at least one of the following: result game data when the at least two teammate virtual characters leave the scene of the game session, or dynamic game data when the at least two teammate virtual characters are in the scene of the game session. The game session screen currently displayed in the graphical user interface is controlled to change to the first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data. In this way, real-time game screens and the game result pictures of each teammate virtual character can be respectively displayed by using at least two display areas, allowing players to quickly and simultaneously understand the game state of each teammate, which avoids the changes in the game states of other teammates being missed by the player, enriches players' information acquisition during the waiting process, enhances the emotional connection between players and teammates, and improves the players' gaming experiences.

After the step of controlling the game session screen currently displayed in the graphical user interface to change to the first game observation screen, the method further includes: in response to the teammate virtual character being in the scene of the game session, controlling the display area corresponding to the teammate virtual character to display a dynamic game screen generated based on the dynamic game data of the teammate virtual character; and in response to the teammate virtual character leaving the scene of the game session, controlling the dynamic game screen currently displayed in the display area to change to the game result picture generated based on the result game data of the teammate virtual character.

The above method further includes: in response to an attribute value of the controlled virtual character meeting a first preset condition, controlling the controlled virtual character to leave the scene of the game session as a second identity; and controlling the game session screen currently displayed in the graphical user interface to change to a second game observation screen, wherein the second game observation screen displays the game screen of the teammate virtual character in the scene of the game session.

Before the step of controlling, in response to the first target game event for the controlled virtual character in the scene of the game session, the controlled virtual character to leave the scene of the game session as the first identity, the method further includes: in response to a game task of the game session meeting a second preset condition, providing a target virtual object in the scene of the game session, wherein a triggering event for the target virtual object is configured for a virtual character in the scene of the game session to perform a target game behavior.

The above method further includes: in response to an attribute value of the controlled virtual character meeting a first preset condition, controlling the controlled virtual character to leave the scene of the game session as a second identity; obtaining the game data of the at least two teammate virtual characters, wherein the game data includes at least one of: the result game data when leaving the scene of the game session and the dynamic game data when in the scene of the game session; and controlling the game session screen currently displayed in the graphical user interface to change to the first game observation screen, wherein the first game observation screen includes at least two display areas corresponding to the at least two teammate virtual characters, and each display area displays the game screen generated based on the game data of the teammate virtual character corresponding thereto, and wherein the game screen generated based on the dynamic game data of the teammate virtual character corresponding thereto includes the screen formed by capturing the scene of the game session through the virtual camera corresponding to the teammate virtual character, and the game screen generated based on the result game data of the teammate virtual character corresponding thereto includes the game result picture corresponding to the result game data.

The game result picture corresponding to the result game data of the teammate virtual character includes at least one of the following: the teammate virtual character, a character number of the teammate virtual character, or a game result identifier of the teammate virtual character. The game result identifier is configured to indicate a first target game event related to the teammate virtual character or that an attribute value of the teammate virtual character meets a first preset condition.

The result game data of the teammate virtual character mentioned above includes the first result game data and second result game data. The display format of a first game result picture corresponding to the first result game data is a first display format, and a first game result identifier of the teammate virtual character included in the first game result picture is configured to indicate the first target game event related to the teammate virtual character. The display format of a second game result picture corresponding to the second result game data is a second display format, and a second game result identifier of the teammate virtual character included in the second game result picture is configured to indicate that the attribute value of the teammate virtual character meets the first preset condition.

The first display format is used to enhance a visual display effect applied to the first game result picture, and the second display format is used to reduce the visual display effect applied to the second game result picture.

The game screen generated based on the dynamic game data of the teammate virtual character corresponding thereto further includes a game result identifier of the teammate virtual character, and the game result identifier is configured to indicate that the teammate virtual character is in the scene of the game session.

The first game observation screen further includes a display area corresponding to the controlled virtual character, and the display area corresponding to the controlled virtual character displays the game screen generated based on the result game data of the controlled virtual character.

The above method further includes: or decreasing, based on device performance of a terminal device, a resolution and/or a video frame rate of the game screen generated based on the dynamic game data of the teammate virtual character corresponding thereto.

The first game observation screen further includes game countdown, and the game countdown is configured to indicate a remaining game time for the teammate virtual character.

The first game observation screen further includes a first value and a second value, the first value is configured to indicate number of virtual characters who leave the scene of the game session as the first identity, and the second value is configured to indicate a sum of number of the controlled virtual character and the teammate virtual characters.

The above method further includes: in response to a specified event being triggered, controlling the game session to end and controlling the first game observation screen displayed in the graphical user interface to change to a game settlement screen, wherein the specified event includes that countdown to the game session ends or the at least two teammate virtual characters all leave the scene of the game session.

The step of controlling the first game observation screen displayed in the graphical user interface to change to the game settlement screen includes: in response to number of virtual characters who leave the scene of the game session as the first identity meeting a preset threshold, controlling the game session to win, and controlling the first game observation screen displayed in the graphical user interface to change to a first game settlement screen, wherein the first game settlement screen includes victory information about the game session; and in response to the number of virtual characters who leave the scene of the game session as the first identity not meeting the preset threshold, controlling the game session to fail, and controlling the first game observation screen displayed in the graphical user interface to change to a second game settlement screen, wherein the second game settlement screen includes failed information about the game session.

The above step of increasing or decreasing, based on the device performance of the terminal device, the resolution and/or the video frame rate of the game screen generated based on the dynamic game data of the teammate virtual character corresponding thereto includes: if the device performance of the terminal device is lower than preset performance, controlling the game screen generated based on the dynamic game data of the teammate virtual character corresponding thereto to be updated to the game result picture corresponding to the dynamic game data, wherein the game result picture at least includes the teammate virtual character displayed in a third display format, a character number of the teammate virtual character, and a game result identifier of the teammate virtual character, and the game result identifier is configured to indicate that the teammate virtual character is in the scene of the game session.

The above method further includes: in response to a triggering operation on the game screen generated based on the dynamic game data of the teammate virtual character corresponding thereto, controlling the graphical user interface to enlarge and display the game screen generated based on the dynamic game data of the teammate virtual character; and in response to a triggering operation on the game screen generated based on the result game data of the teammate virtual character corresponding thereto, controlling the display area corresponding thereto to switch and display game related data of the teammate virtual character, wherein the game related data at least includes a character level, a game time, and a game ranking of the teammate virtual character.

The above method includes: in response to number of teammate virtual characters greater than or equal to a specified threshold, the first game observation screen includes a partial display area; and in response to a sliding operation on the first game observation screen, controlling the partial display area on the first game observation screen to move towards a sliding direction of the sliding operation, and controlling a hidden display area on the first game observation screen to be displayed.

Embodiments of the present disclosure also provide a computer-readable storage medium, which stores computer executable instructions. When the computer executable instructions are called and executed by a processor, the computer executable instructions cause the processor to implement game information display method described above. The method includes following steps.

In response to the start command for the game session, the controlled virtual character is controlled to enter the scene of the game session, and the game session screen is displayed through the graphical user interface. The game session screen includes the screen formed by capturing the scene of the game session through the virtual camera corresponding to the controlled virtual character, and the scene of the game session includes at least two teammate virtual characters in the same camp as the controlled virtual character. In response to the first target game event for the controlled virtual character in the scene of the game session, the controlled virtual character is controlled to leave the scene of the game session as the first identity. The game data of at least two teammate virtual characters is obtained, and the game data includes at least one of the following: result game data when the at least two teammate virtual characters leave the scene of the game session, or dynamic game data when the at least two teammate virtual characters are in the scene of the game session. The game session screen currently displayed in the graphical user interface is controlled to change to the first game observation screen. The first game observation screen includes at least two display areas, the at least two display areas correspond to the at least two teammate virtual characters, and each display area displays a game screen generated based on the game data of the teammate virtual character corresponding thereto. The game screen generated based on the dynamic game data of the teammate virtual character corresponding thereto includes the screen formed by capturing the scene of the game session through the virtual camera corresponding to the corresponding teammate virtual character. The game screen generated based on the result game data of the teammate virtual character corresponding thereto includes a game result picture corresponding to the result game data. In this way, real-time game screens and the game result pictures of each teammate virtual character can be respectively displayed by using at least two display areas, allowing players to quickly and simultaneously understand the game state of each teammate, which avoids the changes in the game states of other teammates being missed by the player, enriches players' information acquisition during the waiting process, enhances the emotional connection between players and teammates, and improves the players' gaming experiences.

After the step of controlling the game session screen currently displayed in the graphical user interface to change to the first game observation screen, the method further includes: in response to the teammate virtual character being in the scene of the game session, controlling the display area corresponding to the teammate virtual character to display a dynamic game screen generated based on the dynamic game data of the teammate virtual character; and in response to the teammate virtual character leaving the scene of the game session, controlling the dynamic game screen currently displayed in the display area to change to the game result picture generated based on the result game data of the teammate virtual character.

The above method further includes: in response to an attribute value of the controlled virtual character meeting a first preset condition, controlling the controlled virtual character to leave the scene of the game session as a second identity; and controlling the game session screen currently displayed in the graphical user interface to change to a second game observation screen, wherein the second game observation screen displays the game screen of the teammate virtual character in the scene of the game session.

Before the step of controlling, in response to the first target game event for the controlled virtual character in the scene of the game session, the controlled virtual character to leave the scene of the game session as the first identity, the method further includes: in response to a game task of the game session meeting a second preset condition, providing a target virtual object in the scene of the game session, wherein a triggering event for the target virtual object is configured for a virtual character in the scene of the game session to perform a target game behavior.

The above method further includes: in response to an attribute value of the controlled virtual character meeting a first preset condition, controlling the controlled virtual character to leave the scene of the game session as a second identity; obtaining the game data of the at least two teammate virtual characters, wherein the game data includes at least one of: the result game data when leaving the scene of the game session and the dynamic game data when in the scene of the game session; and controlling the game session screen currently displayed in the graphical user interface to change to the first game observation screen, wherein the first game observation screen includes at least two display areas corresponding to the at least two teammate virtual characters, and each display area displays the game screen generated based on the game data of the teammate virtual character corresponding thereto, and wherein the game screen generated based on the dynamic game data of the teammate virtual character corresponding thereto includes the screen formed by capturing the scene of the game session through the virtual camera corresponding to the teammate virtual character, and the game screen generated based on the result game data of the teammate virtual character corresponding thereto includes the game result picture corresponding to the result game data.

The game result picture corresponding to the result game data of the teammate virtual character includes at least one of the following: the teammate virtual character, a character number of the teammate virtual character, or a game result identifier of the teammate virtual character. The game result identifier is configured to indicate a first target game event related to the teammate virtual character or that an attribute value of the teammate virtual character meets a first preset condition.

The result game data of the teammate virtual character mentioned above includes the first result game data and second result game data. The display format of a first game result picture corresponding to the first result game data is a first display format, and a first game result identifier of the teammate virtual character included in the first game result picture is configured to indicate the first target game event related to the teammate virtual character. The display format of a second game result picture corresponding to the second result game data is a second display format, and a second game result identifier of the teammate virtual character included in the second game result picture is configured to indicate that the attribute value of the teammate virtual character meets the first preset condition.

The first display format is used to enhance a visual display effect applied to the first game result picture, and the second display format is used to reduce the visual display effect applied to the second game result picture.

The game screen generated based on the dynamic game data of the teammate virtual character corresponding thereto further includes a game result identifier of the teammate virtual character, and the game result identifier is configured to indicate that the teammate virtual character is in the scene of the game session.

The first game observation screen further includes a display area corresponding to the controlled virtual character, and the display area corresponding to the controlled virtual character displays the game screen generated based on the result game data of the controlled virtual character.

The above method further includes: or decreasing, based on device performance of a terminal device, a resolution and/or a video frame rate of the game screen generated based on the dynamic game data of the teammate virtual character corresponding thereto.

The first game observation screen further includes game countdown, and the game countdown is configured to indicate a remaining game time for the teammate virtual character.

The first game observation screen further includes a first value and a second value, the first value is configured to indicate number of virtual characters who leave the scene of the game session as the first identity, and the second value is configured to indicate a sum of number of the controlled virtual character and the teammate virtual characters.

The above method further includes: in response to a specified event being triggered, controlling the game session to end and controlling the first game observation screen displayed in the graphical user interface to change to a game settlement screen, wherein the specified event includes that countdown to the game session ends or the at least two teammate virtual characters all leave the scene of the game session.

The step of controlling the first game observation screen displayed in the graphical user interface to change to the game settlement screen includes: in response to number of virtual characters who leave the scene of the game session as the first identity meeting a preset threshold, controlling the game session to win, and controlling the first game observation screen displayed in the graphical user interface to change to a first game settlement screen, wherein the first game settlement screen includes victory information about the game session; and in response to the number of virtual characters who leave the scene of the game session as the first identity not meeting the preset threshold, controlling the game session to fail, and controlling the first game observation screen displayed in the graphical user interface to change to a second game settlement screen, wherein the second game settlement screen includes failed information about the game session.

The above step of increasing or decreasing, based on the device performance of the terminal device, the resolution and/or the video frame rate of the game screen generated based on the dynamic game data of the teammate virtual character corresponding thereto includes: if the device performance of the terminal device is lower than preset performance, controlling the game screen generated based on the dynamic game data of the teammate virtual character corresponding thereto to be updated to the game result picture corresponding to the dynamic game data, wherein the game result picture at least includes the teammate virtual character displayed in a third display format, a character number of the teammate virtual character, and a game result identifier of the teammate virtual character, and the game result identifier is configured to indicate that the teammate virtual character is in the scene of the game session.

The above method further includes: in response to a triggering operation on the game screen generated based on the dynamic game data of the teammate virtual character corresponding thereto, controlling the graphical user interface to enlarge and display the game screen generated based on the dynamic game data of the teammate virtual character; and in response to a triggering operation on the game screen generated based on the result game data of the teammate virtual character corresponding thereto, controlling the display area corresponding thereto to switch and display game related data of the teammate virtual character, wherein the game related data at least includes a character level, a game time, and a game ranking of the teammate virtual character.

The above method includes: in response to number of teammate virtual characters greater than or equal to a specified threshold, the first game observation screen includes a partial display area; and in response to a sliding operation on the first game observation screen, controlling the partial display area on the first game observation screen to move towards a sliding direction of the sliding operation, and controlling a hidden display area on the first game observation screen to be displayed.

The game information display method, the game information display apparatus, and the electronic device provided by embodiments of the present disclosure include a computer-readable storage medium that stores program codes. The instructions included in the program codes can be configured to execute the methods in preceding method embodiments. References can be made to above method embodiments, and will not be repeated here.

Those skilled in the art can clearly understand that, for the convenience and simplicity of description, the specific working process of the above described system and/or device can refer to the corresponding process in above method embodiments, and will not be repeated here.

In addition, in the description of embodiments of the present disclosure, unless otherwise specified and defined, the terms “installation”, “coupling” and “connection” should be understood broadly, for example, they can be fixed connection, removable connection, or integrated connection. They can be mechanical connection or electrical connection. They can be directly connected, or indirectly connected through intermediate media. They can be the connection between two components. For those skilled in the art, the specific meaning of the above terms in the present disclosure can be understood in specific cases.

If the functions are realized in the form of software functional units and sold or used as independent products, they can be stored in a computer readable storage medium. Based on this understanding, the technical solution of the present disclosure can be embodied in the form of a software product, which is stored in a storage medium, A number of instructions are included to enable a computer device (which may be a personal computer, an electronic device, or a network device, etc.) to perform all or part of the steps of the method described in various embodiments of the present disclosure. The aforementioned storage medium includes USB flash disk, mobile hard disk, read only memory (ROM), random access memory (RAM), magnetic disc or optical disc and other media that can store program codes.

In the description of the present disclosure, it should be noted that the terms “center”, “top”, “bottom”, “left”, “right”, “vertical”, “horizontal”, “inside”, “outside”, etc., indicate the orientation or position relationship based on the orientation or position relationship shown in the drawings, only for the convenience of describing the present disclosure and simplifying the description, rather than indicating or implying that the device or element referred to must have a specific orientation, or constructed and operated in a specific orientation, and therefore cannot be understood as a limitation of the present disclosure. In addition, the terms “first”, “second” and “third” are only used for describing purposes and cannot be understood as indicating or implying relative importance.

Finally, it should be noted that the above embodiments are only specific embodiments of the present disclosure, which are used to illustrate the technical solutions of the present disclosure, rather than limiting the present disclosure. The protection scope of the present disclosure is not limited to this. Although detailed explanations of the present disclosure have been provided by referring to the aforementioned embodiments, those skilled in the art should understand that any person familiar with the art can still, within the scope of the disclosed technology, modify or easily come up with changes to the technical solutions described in the aforementioned embodiments, or make equivalent replacements to some of the technical features. These modifications, changes, or replacements do not make the substance of corresponding technical solutions deviate from the spirit and scope of the present disclosure, and should be covered within the protection scope of the present disclosure. Therefore, the protection scope of the present disclosure shall be based on the protection scope of the claims.

1. A game information display method, providing a graphical user interface through a terminal device, and comprising:
in response to a start command for a game session, controlling a controlled virtual character to enter a scene of the game session, and displaying a game session screen corresponding thereto through the graphical user interface, wherein the game session screen comprises a screen formed by capturing the scene of the game session through a virtual camera corresponding to the controlled virtual character, and the scene of the game session comprises at least two teammate virtual characters in the same camp as the controlled virtual character;
in response to a first target game event for the controlled virtual character in the scene of the game session, controlling the controlled virtual character to leave the scene of the game session as a first identity;
obtaining game data of the at least two teammate virtual characters, wherein the game data comprises at least one of: result game data when leaving the scene of the game session and dynamic game data when in the scene of the game session; and
controlling the game session screen currently displayed in the graphical user interface to change to a first game observation screen, wherein the first game observation screen comprises at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto comprises a screen formed by capturing the scene of the game session through a virtual camera corresponding to the teammate virtual character, and the game screen generated based on the result game data of the teammate virtual character corresponding thereto comprises a game result picture corresponding to the result game data.

2. The method according to claim 1, further comprising:
after controlling the game session screen currently displayed in the graphical user interface to change to the first game observation screen,
in response to the teammate virtual character being in the scene of the game session, controlling the display area corresponding to the teammate virtual character to display a dynamic game screen generated based on the dynamic game data of the teammate virtual character; and
in response to the teammate virtual character leaving the scene of the game session, controlling the dynamic game screen currently displayed in the display area to change to the game result picture generated based on the result game data of the teammate virtual character.

3. The method according to claim 1, further comprising:
in response to an attribute value of the controlled virtual character meeting a first preset condition, controlling the controlled virtual character to leave the scene of the game session as a second identity; and
controlling the game session screen currently displayed in the graphical user interface to change to a second game observation screen, wherein the second game observation screen displays the game screen of the teammate virtual character in the scene of the game session.

4. The method according to claim 1, further comprising:
in response to a game task of the game session meeting a second preset condition, providing a target virtual object in the scene of the game session before controlling the controlled virtual character to leave the scene of the game session as the first identity, wherein a triggering event for the target virtual object is configured for at least one of the controlled virtual character or the teammate virtual characters in the scene of the game session to perform a target game behavior.

5. The method according to claim 4, further comprising:
in response to an attribute value of the controlled virtual character meeting a first preset condition, controlling the controlled virtual character to leave the scene of the game session as a second identity;
obtaining the game data of the at least two teammate virtual characters, wherein the game data comprises at least one of: the result game data when leaving the scene of the game session and the dynamic game data when in the scene of the game session; and
controlling the game session screen currently displayed in the graphical user interface to change to the first game observation screen, wherein the first game observation screen comprises at least two display areas corresponding to the at least two teammate virtual characters, and each display area displays the game screen generated based on the game data of the teammate virtual character corresponding thereto, and wherein the game screen generated based on the dynamic game data of the teammate virtual character corresponding thereto comprises the screen formed by capturing the scene of the game session through the virtual camera corresponding to the teammate virtual character, and the game screen generated based on the result game data of the teammate virtual character corresponding thereto comprises the game result picture corresponding to the result game data.

6. The method according to claim 1, wherein the game result picture corresponding to the result game data of the teammate virtual character comprises at least one of:
the teammate virtual character, a character number of the teammate virtual character, or a game result identifier of the teammate virtual character, and the game result identifier is configured to indicate a first target game event related to the teammate virtual character or that an attribute value of the teammate virtual character meets a first preset condition.

7. The method according to claim 6, wherein the result game data of the teammate virtual character comprises first result game data and second result game data;
a display format of a first game result picture corresponding to the first result game data is a first display format, and a first game result identifier of the teammate virtual character included in the first game result picture is configured to indicate the first target game event related to the teammate virtual character; and
a display format of a second game result picture corresponding to the second result game data is a second display format, and a second game result identifier of the teammate virtual character included in the second game result picture is configured to indicate that the attribute value of the teammate virtual character meets the first preset condition.

8. The method according to claim 7, wherein the first display format is used to enhance a visual display effect applied to the first game result picture, and the second display format is used to reduce the visual display effect applied to the second game result picture.

9. The method according to claim 1, wherein the game screen generated based on the dynamic game data of the teammate virtual character corresponding thereto further comprises a game result identifier of the teammate virtual character, and the game result identifier is configured to indicate that the teammate virtual character is in the scene of the game session.

10. The method according to claim 1, wherein the first game observation screen further comprises a display area corresponding to the controlled virtual character, and the display area corresponding to the controlled virtual character displays the game screen generated based on the result game data of the controlled virtual character.

11. The method according to claim 1, further comprising:
increasing or decreasing, based on device performance of a terminal device, at least one of a resolution or a video frame rate of the game screen generated based on the dynamic game data of the teammate virtual character corresponding thereto.

12. The method according to claim 1, wherein the first game observation screen further comprises game countdown, and the game countdown is configured to indicate a remaining game time for the teammate virtual character.

13. The method according to claim 1, wherein the first game observation screen further comprises a first value and a second value, the first value is configured to indicate number of virtual characters who leave the scene of the game session as the first identity, and the second value is configured to indicate a sum of number of the controlled virtual character and the teammate virtual characters.

14. The method according to claim 1, further comprising:
in response to a specified event being triggered, controlling the game session to end and controlling the first game observation screen displayed in the graphical user interface to change to a game settlement screen, wherein the specified event comprises that countdown to the game session ends or the at least two teammate virtual characters all leave the scene of the game session.

15. The method according to claim 14, wherein controlling the first game observation screen displayed in the graphical user interface to change to the game settlement screen, comprises:
in response to number of virtual characters who leave the scene of the game session as the first identity being greater than or equal to a preset threshold, controlling the game session to win, and controlling the first game observation screen displayed in the graphical user interface to change to a first game settlement screen, wherein the first game settlement screen comprises victory information about the game session; and
in response to the number of virtual characters who leave the scene of the game session as the first identity being less than the preset threshold, controlling the game session to fail, and controlling the first game observation screen displayed in the graphical user interface to change to a second game settlement screen, wherein the second game settlement screen comprises failed information about the game session.

16. The method according to claim 11, wherein increasing or decreasing at least one of the resolution or the video frame rate of the game screen generated based on the dynamic game data of the teammate virtual character corresponding thereto, comprises:
if the device performance of the terminal device is lower than preset performance, controlling the game screen generated based on the dynamic game data of the teammate virtual character corresponding thereto to be updated to the game result picture corresponding to the dynamic game data, wherein the game result picture at least comprises the teammate virtual character displayed in a third display format, a character number of the teammate virtual character, and a game result identifier of the teammate virtual character, and the game result identifier is configured to indicate that the teammate virtual character is in the scene of the game session.

17. The method according to claim 1, further comprising:
in response to a triggering operation on the game screen generated based on the dynamic game data of the teammate virtual character corresponding thereto, controlling the graphical user interface to enlarge and display the game screen generated based on the dynamic game data of the teammate virtual character; and
in response to a triggering operation on the game screen generated based on the result game data of the teammate virtual character corresponding thereto, controlling the display area corresponding thereto to switch and display game related data of the teammate virtual character, wherein the game related data at least comprises a character level, a game time, and a game ranking of the teammate virtual character.

18. The method according to claim 1, further comprising:
in response to number of teammate virtual characters being greater than or equal to a specified threshold, the first game observation screen comprises a partial display area; and
in response to a sliding operation on the first game observation screen, controlling the partial display area on the first game observation screen to move towards a sliding direction of the sliding operation, and controlling a hidden display area on the first game observation screen to be displayed.

19. (canceled)

20. An electronic device comprising a processor and a memory, wherein the memory is configured to store computer executable instructions that can be executed by the processor, and the processor is configured to execute the computer executable instructions to implement a game information display method, the method providing a graphical user interface through a terminal device, and comprising:
in response to a start command for a game session, controlling a controlled virtual character to enter a scene of the game session, and displaying a game session screen corresponding thereto through the graphical user interface, wherein the game session screen comprises a screen formed by capturing the scene of the game session through a virtual camera corresponding to the controlled virtual character, and the scene of the game session comprises at least two teammate virtual characters in the same camp as the controlled virtual character;
in response to a first target game event for the controlled virtual character in the scene of the game session, controlling the controlled virtual character to leave the scene of the game session as a first identity;
obtaining game data of the at least two teammate virtual characters, wherein the game data comprises at least one of: result game data when leaving the scene of the game session and dynamic game data when in the scene of the game session; and
controlling the game session screen currently displayed in the graphical user interface to change to a first game observation screen, wherein the first game observation screen comprises at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto comprises a screen formed by capturing the scene of the game session through a virtual camera corresponding to the teammate virtual character, and the game screen generated based on the result game data of the teammate virtual character corresponding thereto comprises a game result picture corresponding to the result game data.

21. non-transitory computer-readable storage medium having computer executable instructions stored thereon, which when called and executed by a processor, cause the processor to implement a game information display method, the method providing a graphical user interface through a terminal device, and comprising:
in response to a start command for a game session, controlling a controlled virtual character to enter a scene of the game session, and displaying a game session screen corresponding thereto through the graphical user interface, wherein the game session screen comprises a screen formed by capturing the scene of the game session through a virtual camera corresponding to the controlled virtual character, and the scene of the game session comprises at least two teammate virtual characters in the same camp as the controlled virtual character;
in response to a first target game event for the controlled virtual character in the scene of the game session, controlling the controlled virtual character to leave the scene of the game session as a first identity;
obtaining game data of the at least two teammate virtual characters, wherein the game data comprises at least one of: result game data when leaving the scene of the game session and dynamic game data when in the scene of the game session; and
controlling the game session screen currently displayed in the graphical user interface to change to a first game observation screen, wherein the first game observation screen comprises at least two display areas corresponding to the at least two teammate virtual characters, and each display area displays a game screen generated based on the game data of the teammate virtual character corresponding thereto, and wherein the game screen generated based on the dynamic game data of the teammate virtual character corresponding thereto comprises a screen formed by capturing the scene of the game session through a virtual camera corresponding to the teammate virtual character, and the game screen generated based on the result game data of the teammate virtual character corresponding thereto comprises a game result picture corresponding to the result game data.
